(19) United States
(12) Patent Application Publication
(10) Pub. No.: US 2026/0145499 A1
(43) Pub. Date: May 28, 2026

(54) PICKUP TRUCK REAR COVER WITH A COATING

(71) Applicant: WENZHOU L-RAY AUTO PARTS CO., LTD., WENZHOU (CN)

(72) Inventors: Dingqi MA, WENZHOU (CN); Shangyi XIE, WENZHOU (CN)

(21) Appl. No.: 19/032,128

(22) Filed: Jan. 20, 2025

(30) Foreign Application Priority Data
Nov. 22, 2024 (CN) 202411680193.X

(51) Int. Cl. B60J 7/14

(52) U.S. Cl. CPC B60J 7/141

(57) ABSTRACT

The present disclosure discloses a pickup truck car cover, including a track, with at least one track is provided at a position of at least one frame component facing the rear cargo hopper. Locking member, is provided with a rod seat that is slidingly connected to the slide groove and having an internal channel. Guide rod, is provided with a head and a rod body. Clamping seat, is provided with a horizontal plate and two side ear plates, both ear plates is provided with guide blocks on the side near each other. This disclosure significantly reduces the fixing steps by adding a slidable locking part on the track.

### CROSS-REFERENCE TO RELATED APPLICATIONS

This application claims priority to Chinese Application 202411680193.X, filed on Nov. 22, 2024, which is incorporated herein by reference in its entirety.

### FIELD

Present disclosure is relevant to field of automotive parts, especially a pickup truck rear cover.

### BACKGROUND

Pickup trucks, as a common type of vehicle, offer car-like comfort without losing power. Due to its strong cargo carrying and adaptability to poor road conditions and its strong overall performance, pickup trucks have become one of the most common off-road vehicles nowadays. In order to adapt to more diverse environments, most existing pickup trucks need to be fitted with a car cover, which is made of multiple panels spliced together. When in use, the car cover will be folded, when not in use it will lay flat to cover the rear cargo hopper.

In the process of achieving both flat and folded states, the inventor discovered that the pickup truck rear cover in its flat state prone to loosen during the traveling of the vehicle. However, existing fixing steps are cumbersome if they are to be secured.

The embodiments of the present disclosure provide a pickup truck rear cover to at least address the problem of cumbersome steps involved in fixing the pickup truck rear cover in its flat state.

In order to solve the above problems of the existing technology, the solution adopted in the disclosure is as follows:

A pickup truck rear cover, for application on a pickup truck to either cover or expose the rear cargo hopper. A pickup truck rear cover is provided with a combination component and a leather positioned above the component. The combination component includes multiple frame components spliced together, where adjacent frame components are rotationally connected, each frame component is enclosed by multiple frames. In one embodiment, the pickup truck rear cover further includes:

A track, with at least one track is provided at a position of at least one frame component facing the rear cargo hopper. the track is provided with a sliding groove.

Locking member, includes:

A rod seat, is slidingly connected with the sliding groove and having an internal channel.

A guide rod, is provided with a head and a rod body. The head is slidably connected to the channel.

A clamping seat, is provided with a horizontal plate and two side ear plates. One side of the horizontal plate is provided with a clamping plate perpendicular to its upper surface, while the other side is provided with a guide hole, where the rod body is inserted into the guide hole. Both ear plates are provided with a guide block on the side near each other

A pressing lever is provided with an eccentric seat and a handle. A Flange is formed by extending outwardly from the edges of the eccentric seat. A rotating shaft is rotationally connected to the eccentric position of the eccentric seat. A through-hole is radially drilled along the rotating shaft to secure the rod body of the guide rod.

When the pressing lever is adjusted to a horizontal position, the rod seat is slid downward along the rear cargo hopper edge of the pickup truck until the clamping plate contacts the lower edge of the rear cargo hopper. By rotating the pressing lever clockwise: the eccentric seat rotates along the outer wall of the rotating shaft, the flanges slide along the guide blocks, the eccentric seat pushes the clamping plate of the clamping seat towards the truck body, and securing the pickup truck rear cover to the rear cargo hopper.

The pickup truck rear cover provided in the embodiments of the present disclosure adds a slidable locking member on the track, allowing its movement toward or away from the pickup truck rear cargo hopper. During fixation, the clamping seat only needs to be clamped the lower edge of the pickup truck rear cargo hopper, followed by clockwise rotation of the pressing lever. The eccentric seat drives the clamping plate of the clamping seat to move toward the vehicle body, thereby securing the rear car cover to the rear cargo hopper. This significantly reduces the fixation steps while achieving a firm fixation. When folding the rear car cover, a simple counterclockwise rotation of the pressing lever separates the clamping seat from the pickup truck rear cargo hopper, making the operation straightforward and efficient.

Further, both ends of the track are provided with end caps. A block is slidably connected within the track, and a movement path is formed between the block and the end cap. The rod seat is positioned along this movement path. Each frame component is enclosed by at least three frame and forms a U-shaped structure, the track is parallel to one frame of that and perpendicular to the other two frames, with the end cap is movable within the other two frames. This setting defines the sliding path of the rod seat, preventing its position from shifting. The setting of end caps allows the adjustments to the position of the track.

Further, the inner wall of the channel is provided with a groove, a male plug is inserted into the groove. This setting defines the movement trajectory of the guide rod, preventing the guide rod from separating from the channel.

Further, one side of the rod seat is provided with a through groove, which communicates with the channel. This setting allows the guide rod to swing along the inner wall of the through groove, thereby changing the angle of the guide rod to facilitate its storage.

Further, a guide block is formed by extending outwardly from both side of the through groove. This setting provides guidance and restriction for the guide rod

Further, the head of the guide rod can be in various shapes, including cylindrical, semi-cylindrical, hexagonal, square, star-shaped, D-shaped, “waist-shaped,” mushroom-shaped, or a combination where one half is semicircular, and the other half resembles part of a mushroom shape. With this design, the shape of the guide rod head can be specifically designed according to requirements.

Further, the contact surfaces of the clamping seat and the pressing lever are respectively provided with a limiting groove and a limiting block, and the limiting block matches the limiting groove. With this design, the relative rotational angle between the pressing lever and the clamping seat can be limited, preventing excessive displacement that could lead to loosening and reduced fixation effectiveness.

Further, when the pickup truck rear cover is folded along the direction from the tail of the vehicle towards the front to form a folded state, a fixing component is provided between the folded section facing the front of the vehicle and the leather on the bottom of the car cover. The fixing component includes a positioning block, a webbing, a male plug, and a socket. The positioning block is provided with a fixing hole. One end of the webbing is passed and secured in the fixing hole, while the other end is threaded and fixed to the male plug, which is interlocked and secured with the socket. With this design, the folded pickup truck rear cover can be fixed, preventing it from flipping over during driving or in windy weather.

Further, corner pieces are provided at the corners of the pickup truck rear cover. The corner piece includes a transition block and a gasket. A hole is provided in the transition block, the leather is fixed to the hole through screws. The screws pass through the gasket, securing the gasket and the leather to the transition block. An elastic body is provided on the exterior of the gasket.

Further, an anti-detachment component is arranged between the pickup truck rear cover and the vehicle body of the pickup truck. The anti-detachment component includes:

A first clamp and a second clamp is located on the left and right sides of the vehicle body, with the first clamp rotatably connected to the second clamp. A hole is provided on the upper surface of the second clamp.

A fastener and a nut, where the fastener passes through the second clamp and the first clamp and is threadedly connected to the nut.

A sliding block is slidably connected to the frame.

A strap, one end of the strap is looped around the sliding block, and the other end is provided with a loop. The loop is connected to the hole through the anti-detachment ring. A reinforcement mechanism is added between the pickup truck rear cover and the vehicle body to prevent separation of the rear car cover from the vehicle body in extreme cases.

### BRIEF DESCRIPTION OF THE DRAWINGS

FIG. 1 is a first perspective view schematic diagram of the pickup truck rear cover in a flat state according to the embodiment of the present disclosure;

FIG. 2 is a three-dimensional schematic diagram of the locking member in the embodiment of the present disclosure;

FIG. 3 is an exploded view of the locking member in the embodiment of the present disclosure;

FIG. 4 is a schematic diagram of the rod seat in the embodiment of the present disclosure;

FIG. 5 is a schematic diagram of the guide rod in the embodiment of the present disclosure;

FIG. 6 is a schematic diagram of another embodiment of the guide rod;

FIG. 7 is a schematic diagram of yet another embodiment of the guide rod;

FIG. 8 is a schematic diagram of still another embodiment of the guide rod;

FIG. 9 is a first perspective view schematic diagram of the clamping seat in the embodiment of the present disclosure;

FIG. 10 is a second perspective view schematic diagram of the clamping seat in the embodiment of the present disclosure;

FIG. 11 is a schematic diagram of the pressing lever in the embodiment of the present disclosure;

FIG. 12 is an component diagram of the pressing lever and the clamping seat in the embodiment of the present disclosure;

FIG. 13 is a diagram of the folded state of the pickup truck rear cover in the embodiment of the present disclosure;

FIG. 14 is a schematic diagram of the fixing component in the embodiment of the present disclosure;

FIG. 15 is a second perspective view schematic diagram of the pickup truck rear cover in a flat state in the embodiment of the present disclosure;

FIG. 16 is an enlarged view of point A in FIG. 15;

FIG. 17 is a perspective view of the gasket at the position shown in FIG. 16;

FIG. 18 is a partial component diagram of the pickup truck rear cover and the vehicle body in the embodiment of the present disclosure;

FIG. 19 is a partial connection schematic diagram of the pickup truck rear cover and the vehicle body in the embodiment of the present disclosure;

FIG. 20 is a first perspective view schematic diagram of the anti-detachment component in the embodiment of the present disclosure;

FIG. 21 is a second perspective view schematic diagram of the anti-detachment component in the embodiment of the present disclosure;

FIG. 22 is a schematic diagram I of other embodiments of the guide rod;

FIG. 23 is a schematic diagram II of other embodiments of the guide rod;

FIG. 24 is a schematic diagram III of other embodiments of the guide rod;

FIG. 25 is a schematic diagram IV of other embodiments of the guide rod.

### DETAILED DESCRIPTION OF THE DISCLOSURE

The following instruction further explains the disclosure's concrete implementation method.

In the description in present disclosure, it is to be understood that the orientation or positional relationships indicated by the terms “top”, “bottom”, “inside”, “outside”, “top”, “bottom”, “top”, “bottom”, “inside”, “bottom”, “inside”, “outside”, etc. are based on the orientation or positional relationships shown in the accompanying drawings, which serve only to facilitate the description in present disclosure and simplify the description, and are not to be construed as limiting the present disclosure in any way as they indicate or imply that the device or element referred to must be constructed and operated with a specific orientation or be constructed and operated in a specific orientation.

In the description of the disclosure, it should also be noted that, unless otherwise expressly specified and limited, the terms “arranged,” “installed,” “connected,” and “combined” should be understood in a broad sense. for example, it may be a fixing connecting, it can also be a detachable connecting or an integral connecting. it can be a mechanical connecting or an electrical connecting. it can be a direct connecting or an indirect connecting through an intermediate media. And it can be internal connecting within two components. Specific meanings of the above terms in the present disclosure can be understood in specific situations.

In this disclosure, unless otherwise stated, directional terms such as “axial,” “circumferential,” and “radial” generally refer to directions defined relative to the rotational axis of the rotor in the drive motor. “Inner” and “outer” refer to the inside and outside of the respective component profiles. The use of terms such as “first,” “second,” etc., is intended to distinguish between different components and does not imply any sequential or hierarchical importance. Furthermore, in the following description, when referring to the drawings, the same reference numerals in different drawings indicate the same or similar elements, unless otherwise explained.

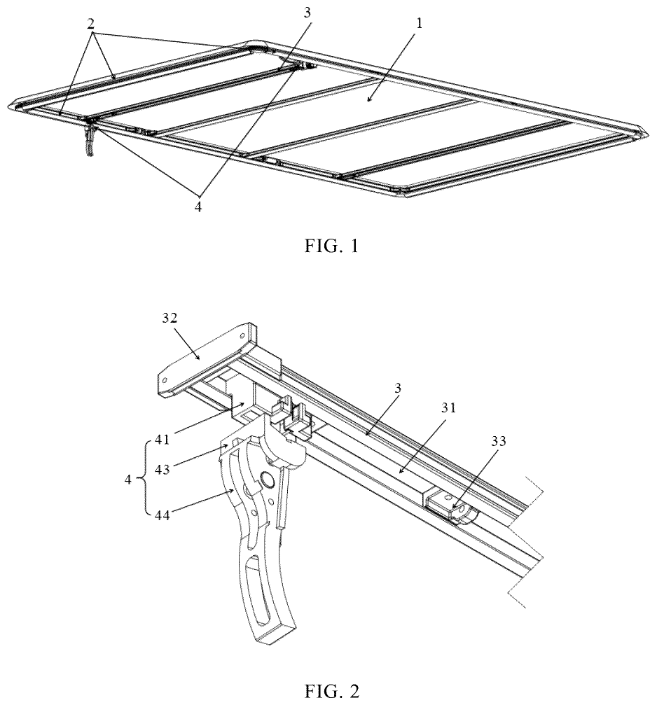

The present disclosure discloses a pickup truck rear cover, applied on a pickup truck to either cover or expose the rear cargo hopper. See FIG. 1, a pickup truck rear cover consists of a combination component and a leather 1 positioned above the component. The combination component includes multiple frame components 2 spliced together, where adjacent frame components are rotationally connected, each frame component is enclosed by multiple frames. In one embodiment, the pickup truck rear cover further includes:
See FIG. 2, a track 3, with at least one track 3 is provided at a position of at least one frame component facing the rear cargo hopper. the track 3 is provided with a sliding groove 31.

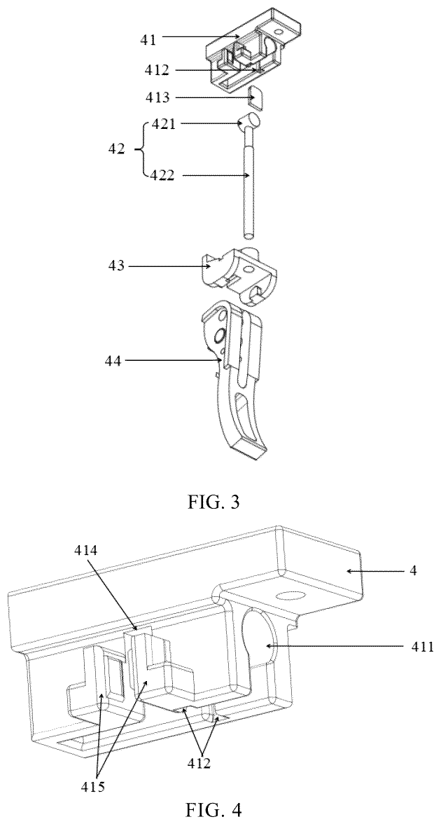

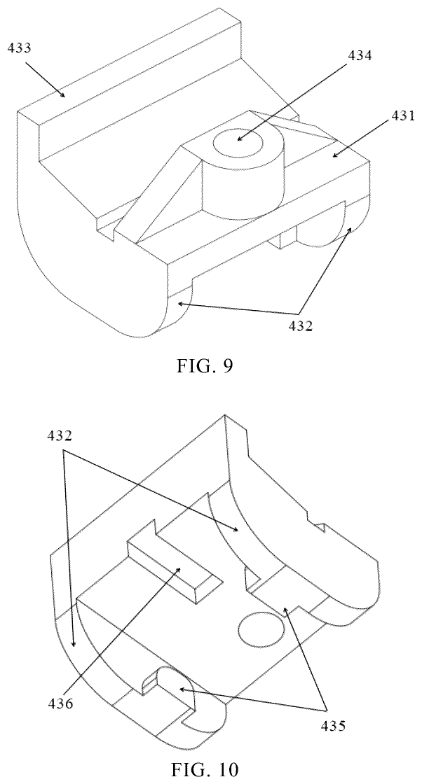

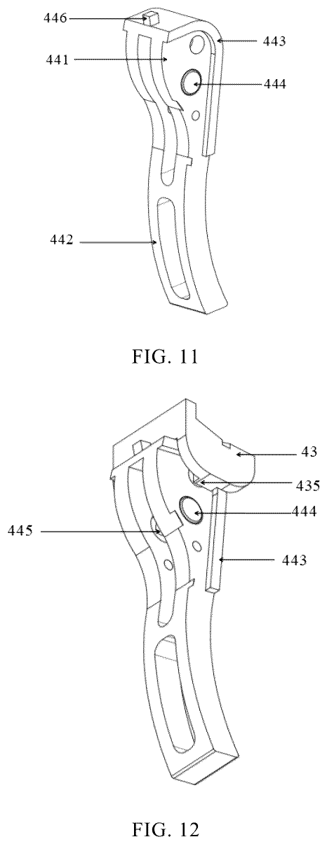

See FIG. 3, the following is a specific embodiment of the above mentioned locking member 4, includes:
See FIG. 4, the following is a specific embodiment of the above mentioned rod seat 41. A rod seat is slidingly connected with the sliding groove 31 and having an internal channel 411.
See FIG. 3, the following is a specific embodiment of the above mentioned guide rod 42. A guide rod is provided with a head 421 and a rod body 422. The head 421 is slidably connected to the channel 411.
See FIGS. 9 and 10, the following is a specific embodiment of the above mentioned clamping seat 43. A clamping seat 43 is provided with a horizontal plate 431 and two side ear plates 432. One side of the horizontal plate 431 is provided with a clamping plate 433 perpendicular to its upper surface, while the other side is provided with a guide hole 434, where the rod body 422 is inserted into the guide hole 434. Both ear plate 432 are provided with a guide block 435 on the side near each other
See FIG. 11, the following is a specific embodiment of the above mentioned pressing lever 44. A pressing lever 44 is provided with an eccentric seat 441 and a handle 442. A Flange 443 is formed by extending outwardly from the edges of the eccentric seat 441. A rotating shaft 444 is rotationally connected to the eccentric position of the eccentric seat 441. A through-hole 445 is radially drilled along the rotating shaft 444 to secure the rod body 422 of the guide rod 42.
See FIG. 12, when the pressing lever 44 is adjusted to a horizontal position, the rod seat 41 is slid downward along the rear cargo hopper edge of the pickup truck until the clamping plate 433 contacts the lower edge of the rear cargo hopper. By rotating the pressing lever 44 clockwise: the eccentric seat 441 rotates along the outer wall of the rotating shaft 444, the flanges 443 slide along the guide blocks 435, the eccentric seat 441 pushes the clamping plate 433 of the clamping seat 43 towards the truck body, and securing the pickup truck rear cover to the rear cargo hopper.

The pickup truck rear cover provided in the embodiments of the present disclosure adds a slidably locking member on the track, allowing its movement toward or away from the pickup truck rear cargo hopper. During fixation, the clamping seat only needs to be clamped the lower edge of the pickup truck rear cargo hopper, followed by clockwise rotation of the pressing lever. The eccentric seat drives the clamping plate of the clamping seat to move toward the vehicle body, thereby securing the rear car cover to the rear cargo hopper. This significantly reduces the fixation steps while achieving a firm fixation. When folding the rear car cover, a simple counterclockwise rotation of the pressing lever separates the clamping seat from the pickup truck rear cargo hopper, making the operation straightforward and efficient.

Further see FIG. 2, in order to define the sliding path of the rod seat 41, both ends of the track 3 are provided with end caps 32. A block 33 is slidably connected within the track 3, and a movement path is formed between the block 33 and the end cap 32. The rod seat 41 is positioned along this movement path. Each frame component is enclosed by at least three frame 2 and forms a U-shaped structure, the track 3 is parallel to one frame 2 of that and perpendicular to the other two frames 2, with the end cap 32 is movable within the other two frames 2. This setting defines the sliding path of the rod seat 41, preventing its position from shifting. The setting of end caps 32 allows for adjustments to the position of the track 3.

Further see FIG. 4, to prevent the guide rod 42 from separating from the channel 411, the inner wall of the channel 411 is provided with a groove 412, a male plug 413 is inserted into the groove 412. This setting defines the movement trajectory of the guide rod 42, preventing the guide rod 42 from separating from the channel 411.

Further see FIG. 4, one side of the rod seat 41 is provided with a through groove 414, which communicates with the channel 411. The guide rod 42 swings along the inner wall of the through groove 414, thereby changing the angle of the guide rod 42 to facilitate its storage.

See FIG. 4, a guide block 415 is formed by extending outwardly from both side of the through groove 414, which provides guidance and restriction for the guide rod 42

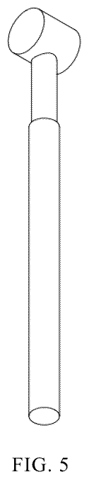

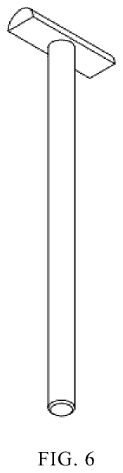

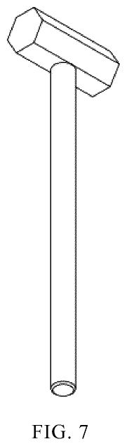

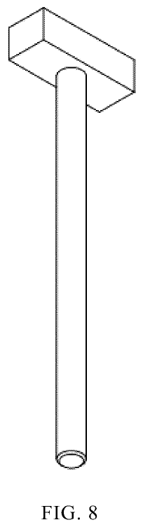

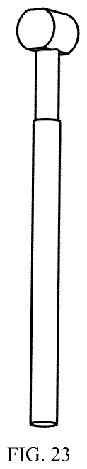

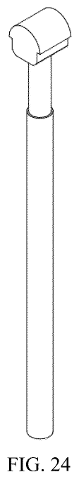

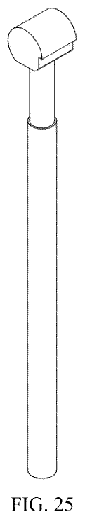

See FIGS. 5, 6, 7, 8, 22, 23, 24, and 25. The head 421 of the guide rod 42 can be in various shapes, including cylindrical, semi-cylindrical, hexagonal, square, star-shaped, D-shaped, “waist-shaped,” mushroom-shaped, or a combination where one half is semicircular, and the other half resembles part of a mushroom shape. The specific shape of the guide rod 42's head can be customized according to requirements. In one embodiment, FIG. 6 and FIG. 22 shows the D-shape (i.e., the head of the guide rod 42 and the rod are cut along a plane smaller than or equal to the diameter). FIG. 23 shows the “waist shape” (i.e., the head of the guide rod 42 is cut parallelly on two sides, with these two planes being of equal or different sizes). FIG. 24 shows the mushroom shape (i.e., the head of the guide rod 42 is semicircular, with the lower part cut on both sides, forming a large round dome on the top resembling a mushroom, while the lower part is smaller in diameter than the dome). FIG. 25 shows a shape where one half is semicircular, and the other half is mushroom-shaped (based on FIG. 24, the left side could be half-mushroom-shaped, or the right side could be half-mushroom-shaped).

See FIGS. 10 and 11, the contact surfaces of the clamping seat 43 and the pressing lever 44 are respectively provided with a limiting groove 436 and a limiting block 446, and the limiting block 446 matches the limiting groove 436. The relative rotational angle between the pressing lever and the clamping seat can be limited to prevent excessive displacement that could lead to loosening and reduced fixation effectiveness.

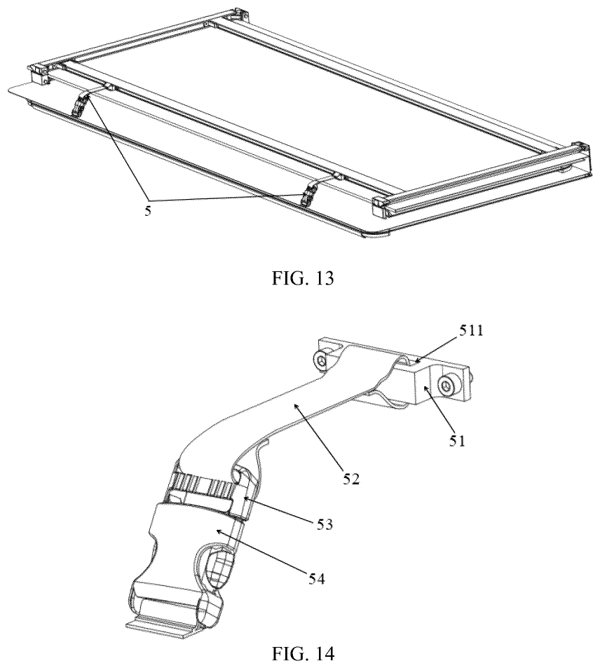

See FIGS. 13 and 14, in order to fix the folded pickup truck rear cover, the pickup truck rear cover is folded along the direction from the tail of the vehicle towards the front to form a folded state. A fixing component 5 is provided between the folded section facing the front of the vehicle and the leather 1 on the bottom of the car cover. The fixing component 5 includes a positioning block 51, a webbing 52, a male plug 53, and a socket 54. The positioning block 51 is provided with a fixing hole 511. One end of the webbing 52 is passed and secured in the fixing hole 511, while the other end is threaded and fixed to the male plug 53, which is interlocked and secured with the socket 54. The folded pickup truck rear cover is fixed for preventing it from flipping over during driving or in windy weather.

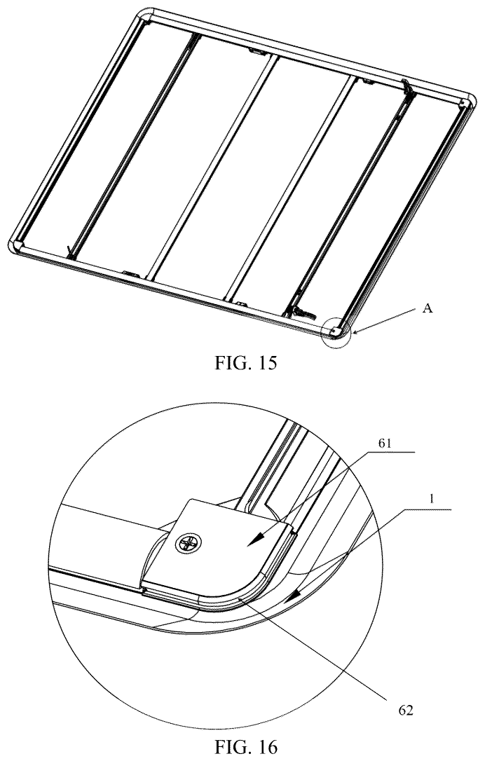

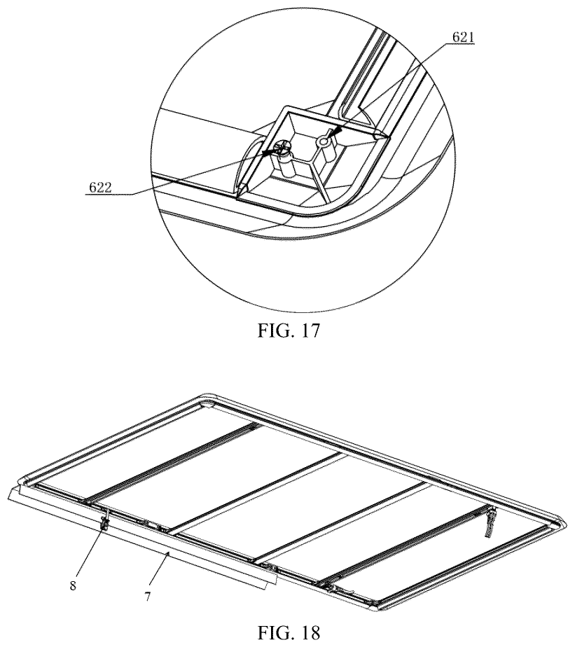

See FIGS. 15, 16 and 17, corner pieces 6 are provided at the corners of the pickup truck rear cover. A hole 621 is provided in the transition block 62, and the leather 1 is fixed to the hole 621 through screws 622. The screws 622 pass through the gasket 61, securing the gasket 621 and the leather 1 to the transition block 62. An elastic body is provided on the exterior of the gasket 61.

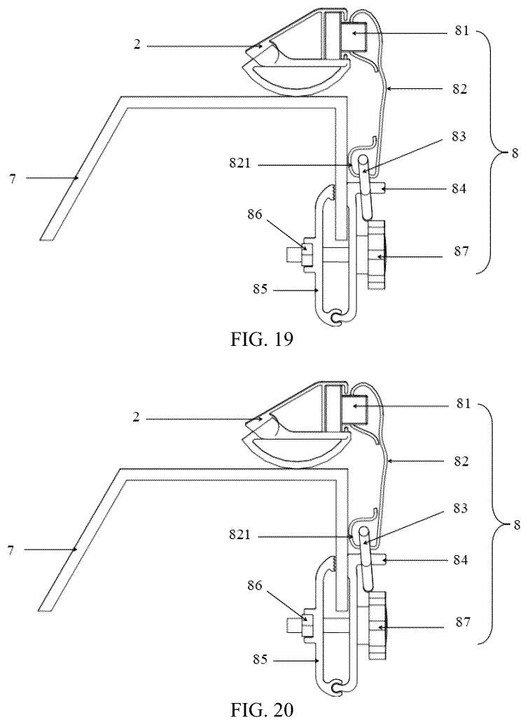

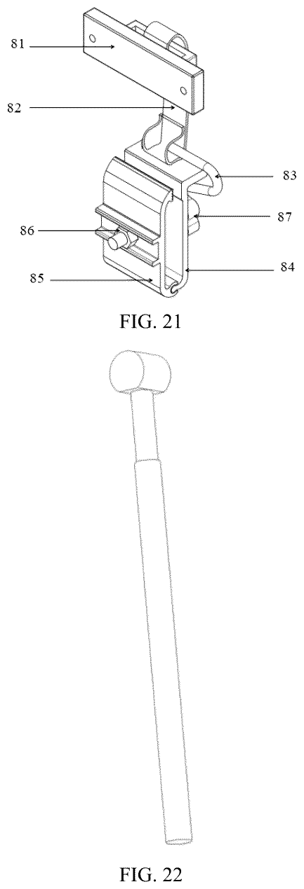

See FIGS. 18, 19, 20 and 21, an anti-detachment component 8 is arranged between the pickup truck rear cover and the vehicle body 7 of the pickup truck. The anti-detachment component 9 includes: A first clamp 85 and a second clamp 84 located on the left and right sides of the vehicle body 7, with the first clamp 85 rotatably connected to the second clamp 84. A hole is provided on the upper surface of the second clamp 84. A fastener 87 and a nut 86, where the fastener 87 passes through the second clamp 84 and the first clamp 85 and is threadedly connected to the nut 86.

A sliding block 81 is slidably connected to the frame 2. A strap 82, one end of the strap 82 is looped around the sliding block 81, and the other end is provided with a loop 821. The loop 821 is connected to the hole through the anti-detachment ring 83. A reinforcement mechanism is added between the pickup truck rear cover and the vehicle body to prevent separation of the rear car cover from the vehicle body in extreme cases.

In the description of this specification, specific features, structures, materials, or characteristics may be combined in any one or more embodiments or examples in a suitable manner.

In the description of this specification, specific features, structures, materials, or characteristics may be combined in any one or more embodiments or examples in a suitable manner.

The disclosure is not limited to the above-mentioned embodiments. Anyone can come up with various other forms of products under the inspiration of the disclosure, however, regardless of any changes in its shape or structure. All embodiments that fall within the scope defined by the claims of the present disclosure shall fall within the scope of protection of the disclosure.

What is claimed is:

1. A pickup truck rear cover, applied on a pickup truck to either cover or expose a rear cargo hopper, wherein the pickup truck rear cover is provided with a combination component and a leather positioned above the component, and wherein the combination component comprises a plurality of frame components spliced together, wherein adjacent frame components are rotationally connected, each frame component is enclosed by multiple frames, wherein the pickup truck rear cover further comprises:
a track, with at least one track is provided at a position of at least one frame component facing the rear cargo hopper, wherein the track is provided with a sliding groove;
a locking member comprising:
a rod seat slidingly connected with the sliding groove and having an internal channel;
a guide rod provided with a head and a rod body, wherein the head is slidably connected to the channel;
a clamping seat provided with a horizontal plate and two side ear plates, wherein one side of the horizontal plate is provided with a clamping plate perpendicular to its upper surface, while the other side is provided with a guide hole, wherein the rod body is inserted into the guide hole, and both ear plates are provided with a guide block on the side near each other;
a pressing lever provided with an eccentric seat and a handle, wherein a flange is formed by extending outwardly from edges of the eccentric seat, a rotating shaft is rotationally connected to the eccentric position of the eccentric seat, and a through-hole is radially drilled along the rotating shaft to secure the rod body of the guide rod;
when the pressing lever is adjusted to a horizontal position, the rod seat slides downward along an edge of the rear cargo hopper of the pickup truck until the clamping plate contacts the lower edge of the rear cargo hopper,
by rotating the pressing lever clockwise: the eccentric seat rotates along an outer wall of the rotating shaft, the flanges slide along the guide blocks, the eccentric seat pushes the clamping plate of the clamping seat towards a truck body, and securing the pickup truck rear cover to the rear cargo hopper.

2. The pickup truck rear cover according to claim 1, wherein:
both ends of the track are provided with end caps, a block is slidably connected within the track, and a movement path is formed between the block and the end cap, the rod seat is provided along this movement path;
each frame component is enclosed by at least three frames and forms a U-shaped structure, the track is parallel to one frame and perpendicular to the other two frames, with the end cap is movable within the other two frames.

3. The pickup truck rear cover according to claim 1, wherein an inner wall of the channel is provided with a groove, a male plug is inserted into the groove.

4. The pickup truck rear cover according to claim 3, wherein one side of the rod seat is provided with a through groove, which communicates with the channel.

5. The pickup truck rear cover according to claim 4, wherein a guide block is formed by extending outwardly from both side of the through groove.

6. The pickup truck rear cover according to claim 1, wherein the head of the guide rod can be in various shapes, including cylindrical, semi-cylindrical, hexagonal, square, star-shaped, D-shaped, waist-shaped, mushroom-shaped, or a combination where one half is semicircular, and the other half resembles part of a mushroom shape.

7. The pickup truck rear cover according to claim 1, wherein the contact surfaces of the clamping seat and the pressing lever are respectively provided with a limiting groove and a limiting block, wherein the limiting block matches the limiting groove.

8. The pickup truck rear cover according to claim 1, wherein when the pickup truck rear cover is folded along the direction from the tail of the vehicle towards the front to form a folded state, a fixing component is provided between the folded section facing the front of the vehicle and the leather on the bottom of the car cover, wherein the fixing component comprises a positioning block, a webbing, a male plug, and a socket, wherein the positioning block is provided with a fixing hole, wherein one end of the webbing is passed and secured to the fixing hole, wherein the other end is threaded and secured to the male plug, wherein the male plug is interlocked and secured with the socket.

9. The pickup truck rear cover according to claim 1, wherein corner pieces are provided at the corners of the pickup truck rear cover, wherein the corner piece comprises a transition block and a gasket, wherein a hole is provided in the transition block, the leather is fixed to the hole through screws, wherein the screws pass through the gasket, securing the gasket and the leather to the transition block, wherein an elastic body is provided on the exterior of the gasket.

10. The pickup truck rear cover according to claim 1, wherein an anti-detachment component is arranged between the pickup truck rear cover and the vehicle body of the pickup truck, wherein the anti-detachment component comprises:
a first clamp and a second clamp are located on the left and right sides of the vehicle body, with the first clamp rotatably connected to the second clamp, wherein a hole is provided on the upper surface of the second clamp;
a fastener and a nut, wherein the fastener passes through the second clamp and the first clamp and is threadedly connected to the nut;
a sliding block is slidably connected to the frame;
a strap, one end of the strap is looped around the sliding block, and the other end is provided with a loop, wherein the loop is connected to the hole through the anti-detachment ring.
